(19) United States
(12) Patent Application Publication
(10) Pub. No.: US 2006/0054726 A1
(43) Pub. Date: Mar. 16, 2006

(54) Blade granulator and method for the production of cut bodies

(76) Inventors: Siegfried Lippert, Koln (DE); Tim Bielfeldt, Koln (DE); Klaus Milling, Koln (DE); Bodo Weickert, Krefeld (DE); Wolfgang Wehnert, Krefeld (DE)

Correspondence Address: BAYER MATERIAL SCIENCE LLC, 100 BAYER ROAD, PITTSBURGH, PA, 15205, US

(21) Appl. No.: 10/490,358

(22) PCT Filed: Sep. 12, 2002
(86) PCT No.: PCT/EP02/10213

§ 371 Date: Aug. 5, 2004

(30) Foreign Application Priority Data
Sep. 25, 2001 (DE) 101 47 159.9

(51) Int. Cl. B02C 18/16

(52) U.S. Cl. 241/65; 241/277

(57) ABSTRACT

A granulating mill for the production of cut pieces from viscous materials and a process for producing such cut pieces are described. The mill comprises gaps between the knives (1, 2) which are at least partially covered with a spray guard (4) which is fixed to the rotor (5).

The invention relates to a granulating mill for the production of cut pieces from viscous materials and a process for producing cut pieces.

A plurality of methods are used for the production of granules or cut pieces from materials that are in the viscous state.

One method consists in feeding the material to a roll mill. The rolls are maintained at a suitable temperature. On the rolls is situated a bead, which is pressed vigorously.

The freshly supplied material is passed onto the bead and worked into the bead. At the same time the material cools down to such an extent that a tough material of suitable viscosity is obtained.

There is drawn off from the rolls a ribbon, e.g. of thermoplastic polymer, which is cooled. Said ribbon is then chopped with a granulator, so that “cubed granules” are obtained. Other shapes may also be cut or stamped out of the ribbon. Such a procedure is e.g. conventional in the processing of doughs in bakeries for the production of bakery products.

A further method consists in pressing out directly via a nozzle a ribbon which is cooled and cut or punched into shapes as above. This presupposes that the liquid may be pressed out of a nozzle in a tough, highly viscous state.

A further method consists in pressing out via a nozzle with many openings. Threads are pressed out, the diameter of which may in addition be varied by stretching. After suitable cooling, threads may either be spun or they may be chopped and granules of a particular shape, mostly in cylinder form, be obtained.

A further method consists in pressing out via a nozzle with many openings. The exiting “threads” are cut directly at the nozzle by means of a cutting device, in most cases knives. Depending on the exit speed and the cutting frequency, cylindrically shaped grains of particular length are obtained.

The invention is based on the last-mentioned process, which has become more and more popular in recent times.

Critical is the viscosity of the material leaving the nozzle, in order that cutting is in fact possible. Cutting is impossible with low-viscosity material. With increasing viscosity, the cut pieces start to become sticky and oily. This leads to glazing, caking and the binding of cut pieces to one another.

Only when the viscosity is sufficiently high are sufficiently solid cut pieces obtained which are able to exist independently.

The cut pieces so obtained are in the case of circular nozzle openings conventionally often far removed from the anticipated cylindrical shape.

Depending on the material, spherical, lens-shaped or shell-shaped granules, for example, are obtained (e.g. in the case of thermoplastic polymers).

The causes of this may be: the surface tension of the material, the varying cooling rate of the inner and the outer material, wherein stresses in the particle are frozen in, as well as elastic relaxation after the exit from the nozzle.

A further reason for the deformation of the cut pieces are mechanical forces during the cutting, during the removal from the cutting knife or during impact against walls or fittings. Longish, flattened cut pieces are often the result of mechanical deformation.

Deformation of the cut pieces is undesirable in most cases.

Many materials, particularly plastics in the viscous state, have poor thermal conductivity and their volume is temperature-dependent to a large extent.

In the case of many materials the surface cools rapidly and hardens. Because of the poor heat conductivity the inside of a particle remains on high temperature, low viscosity and large volume for a prolonged period.

Given the slow rate of cooling of the inner part of a granule, said material undergoes a diminution in volume.

Since the outer envelope is already dimensionally stable, there forms on the inside a cavity in which vacuum is present, the so-called vacuole. With very slow cooling said vacuole does not form. As soon as said cavity is opened, e.g. by mechanical action or due to excessively thin walls, surrounding air or surrounding liquid may penetrate into said cavity. During the further processing, quality losses may occur due to the materials contained in the opened cavities. Enclosed water, for example, causes a foaming during the further processing.

The rate of cooling of the cut piece after the cutting therefore has a great influence on its shape and on its content of vacuoles.

The most common methods of cooling are:
placing of the cut piece in water,
spraying with water,
treatment with vapour, air or other coolants.

It is also a question, immediately after the cutting, of stabilising the shape of the cut piece by suitable cooling and of preventing adhesion to the cutting tools. The cooling must therefore commence already during the cutting. This may be achieved e.g. by spraying of the knives. The knives in their turn swirl the coolant and ensure a contact with coolant mist also during the disengagement of the cut piece from the knife.

A known method of cooling the rotating knives is axial spraying with coolant.

It is disadvantageous that the nozzle openings are then also sprayed and cooled at the same time.

The nozzle openings cool down and close many opening wholly or partially. The result is that the nozzle holes that have remained open have a greater throughput, i.e. form greater cut pieces, and those partially opened form very small cut pieces (glitter, platelets). A broad particle size spectrum is obtained.

The problem of undesirable spraying of the nozzle holes is also to be solved by the invention.

The object of the invention is to provide a granulating mill and a process for producing cut pieces which avoids the disadvantages of the known apparatuses and supplies a comparatively better and more uniform product quality in particular of polymer granules.

The object is achieved according to the invention by the fact that on the granulating mill the gaps between the knives are covered at least in part with a spray guard which is fixed to the rotor.

The invention provides a granulating mill for the production of cut pieces from viscous materials, in particular from polymers, with a liquid spray device, comprising at least one rotor with a plurality of knives arranged on the periphery of the rotor and an extrusion device with die plate which during the operation of the rotor is swept by the knives, characterised in that the gaps between the knives are covered at least in part with a spray guard which is fixed to the rotor.

For example, during the spraying of the knives with coolant the gaps between the knives are protected against coolant by fitting a spray guard as a continuation of the knives. Said spray guard rotates together with the knife. It is attached preferably directly behind the knife and extends to directly before the following knife. The cutting face of the following knife must not be covered, viewed axially, in order that the mouldings cut there are able to snap off. The spray guard is set at a sufficient distance from the nozzle holes of the die plate. The cut pieces slide along on the spray guard, wherein they come into contact with coolant located on the spray guard and stabilise their shape. Grooves, slits or plates optionally imprinted or placed on the spray guard additionally control in a special embodiment the path of the cut piece and its residence time on the spray guard.

Preferably the spray device consists of one or more mist nozzles for generating a liquid mist, which are aligned in the direction of the die plate. The spray guard prevents a direct spraying of the nozzle openings with the spray liquid.

In a preferred embodiment of the invention the spray device is arranged directed onto the rear side of the knives.

In a preferred embodiment of the invention the spray device is arranged on the rotor of the knives.

Special advantages are achieved with an embodiment of the granulating mill in which the liquid supply for the spray device is arranged on or in the rotor and rotates with it, and is passed through pipes into the area of the knives, wherein the outlet opening of the liquid supply is arranged in the area of the knives and points in the direction of the die plate.

A further improvement may be achieved in a particularly preferred embodiment of the invention by coolant (e.g. water) being sprayed onto the head of the rotor. A “catching device” is located there. From the latter, channels and pipes lead to the knives. According to the principle of the rotary pump, the coolant runs along the knife arms to the knives in an outward direction and is there distributed on the cutting face. It is beneficial to allow the outlet opening of the coolant to end at some distance before the knives, in order that the coolant sprays onto the knife axially.

The quality of the cut material may be further improved if in a preferred embodiment the knives are fixed to the rotor by springs and are constructed so as to be conveyable across the die plate by springs. A smooth cut is ensured in this way.

Depending on the application, the nozzles of the die plate are constructed in special shapes, e.g. star shape or else Father Christmas shapes (application to bakery products).

The invention also provides for a process for producing cut pieces or granules from viscous materials by means of a granulating mill with spray device, characterised in that the die plate, in the case of an axial spraying of the knives with a liquid, is protected against direct spraying with the liquid by a spray guard attached to the knife clip and rotating with it.

Preferably a granulating mill according to the invention and described above is used.

There may be used as viscous material a polymer melt, in particular a thermoplastic polymer, selected from the group: polyamide, polycarbonate, polyvinyl chloride, polyolefin, in particular polypropylene, ABS, SAN resin or polyurethane or mixtures of the above-mentioned polymers.

There is used as viscous material particularly preferably polyamide, in particular preferably polyamide which is in particular reinforced with glass fibres and contains a proportion of glass fibres of 15 to 50 wt %, particularly preferably of 20 to 30 wt % of glass fibres.

A cooling liquid, in particular water, may be used as spray liquid.

There serves alternatively as spray liquid a heating fluid, in particular oil, which leads to the heating of the granules. Said procedure is used with advantage in the production of bakery products.

The invention will be explained in detail below with reference to the figures by the examples, which however do not represent a limitation of the invention.

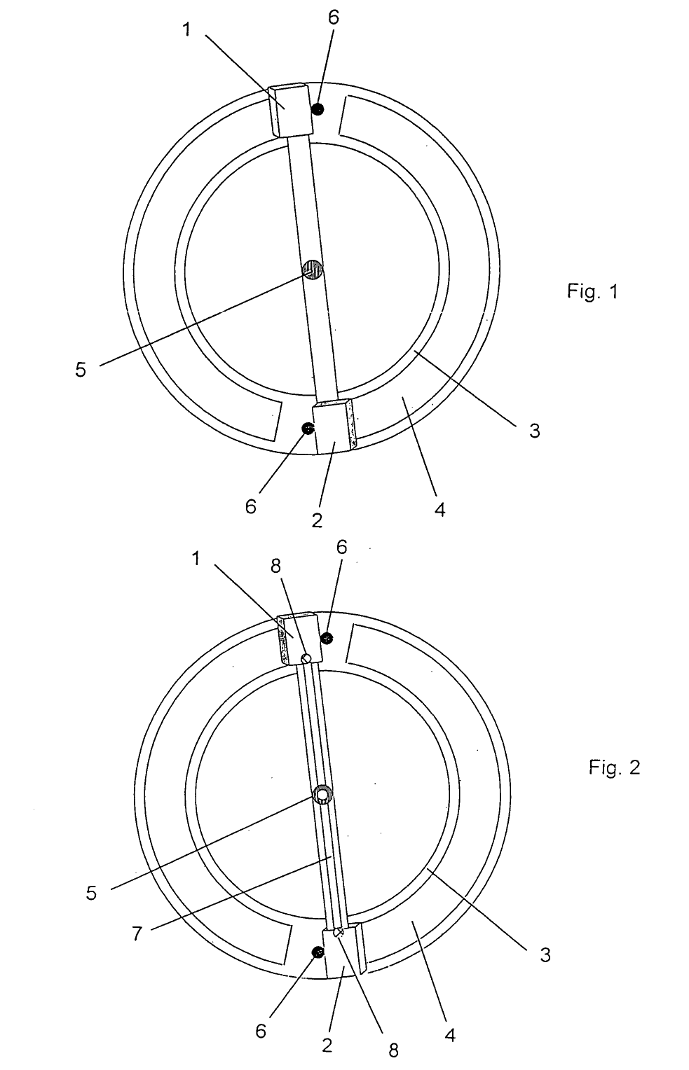

FIG. 1 shows a partial view of the granulating mill according to the invention with opened casing.

FIG. 2 shows an alternative supplying of the cooling liquid.

### EXAMPLE

Two knives 1, 2, which are arranged on the periphery of a rotor 5, rotate axially (cf. FIG. 1; only the view onto the die plate of the granulator without casing and periphery is shown here). The speed comes to 1200 r.p.m. The knives 1, 2 are 10 cm wide on the cutting face. The spray guard 4 is constructed 1 cm wider than the knives 1, 2 in both an inward and outward direction. At the end, namely before the respective following knife 1 or 2, the spray guard 4 is raised by 2 cm and is thus spaced about 2 cm from the nozzle holes 6. It ends 0.5 cm before the cutting face of the following knife.

The spray guard 4 is a semicircular-shaped ring of stainless steel with a central angle of 170°, an outer diameter of 31 cm and an inner diameter of 19 cm.

The die plate 3 with the nozzles 6 has an outer diameter of 30 cm and an inner diameter of 20 cm. The nozzle holes 6 have a diameter of 0.35 cm.

Water with a temperature of 80° C. was sprayed axially onto the knives 1, 2 and the spray guard 4 as coolant.

In a modified granulator device (cf. FIG. 2) the coolant (water) is fed to the additional pipes 7 through the rotor 5 and sprayed via the terminal openings 8 in the area of the knives 1, 2.

1. Granulating mill for the production of cut pieces from viscous materials, in particular from polymers, with a liquid spray device, comprising at least one rotor (5) with a plurality of cutting knives (1, 2) arranged on the periphery of the rotor (5) and an extrusion device with die plate (3) which during the operation of the rotor (5) is swept by the knives (1, 2), characterised in that the gaps between the knives (1, 2) are covered at least partially with a spray guard (4) which is fixed to the rotor (5).

2. Granulating mill according to claim 1, characterised in that the spray device consists of one or more mist nozzles for producing a liquid mist which are aligned in the direction of the die plate (3).

3. Granulating mill according to claim 1 characterised in that the spray device is arranged directed towards the rear side of the knives (1, 2).

4. Granulating mill according to claim 1 characterised in that the spray device is arranged on the rotor (5) of the knives.

5. Granulating mill according to claim 4, characterised in that the liquid supply of the spray device is arranged on or in the rotor (5) and rotates with it, and is fed through pipes (7) into the area of the knives (1, 2), wherein the outlet opening (8) of the liquid supply is arranged in the area of the knives (1, 2) and points in the direction of the die plate (3).

6. Granulating mill according to claim 1 characterised in that the knives (1, 2) are fixed to the rotor (5) by springs and are conveyable across the die plate (3) by springs.

7. Process for producing cut pieces or granules from viscous materials by means of a granulating mill with spray device, characterised in that during an axial spraying of the knives (1, 2) with a liquid, the die plate (3) is protected against direct spraying with the liquid by a spray guard (4) attached to the knife clip and rotating with it.

8. (canceled)

9. Process according to claim 7, characterised in that there is used as viscous material a polymer melt, in particular a thermoplastic polymer, selected from the group consisting of polyamide, polycarbonate, polyvinyl chloride, polyolefin, ABS, SAN resin polyurethane and mixtures of the above polymers.

10. Process according to claim 9, characterised in that there is used as viscous material polyamide, preferably polyamide which is reinforced in particular with glass fibres and contains a portion of glass fibres of 15 to 50 wt %, particularly preferably of 20 to 30 wt % glass fibres.

11. (canceled)

12. (canceled)

13. The process according to claim 7, comprising cutting the viscous material in a granulating mill with a liquid spray device, comprising at least one rotor (5) with a plurality of cutting knives (1, 2) arranged on the periphery of the rotor (5) and an extrusion device with die plate (3) which during the operation of the rotor (5) is swept by the knives (1, 2), characterised in that the gaps between the knives (1, 2) are covered at least partially with a spray guard (4) which is fixed to the rotor (5).
